(19) United States
(12) Patent Application Publication
(10) Pub. No.: US 2016/0341407 A1
(43) Pub. Date: Nov. 24, 2016

(54) Mountable Lighting Devices, Lighting Kits and Methods of Lighting a Workspace

(71) Applicant: Ricky T. Manfred, Millwood, WA (US)

(72) Inventor: Ricky T. Manfred, Millwood, WA (US)

(21) Appl. No.: 14/716,533

(22) Filed: May 19, 2015

(51) Int. Cl. F21V 21/14; F21V 21/096; F21V 21/108; F21V 23/06; F21V 21/30; F21L 14/00; F21V 27/00; F21V 21/092; F21V 21/06

(52) U.S. Cl. CPC F21V 21/145; F21V 21/0925; F21V 21/0965; F21V 21/108; F21V 21/06; F21V 21/30; F21L 14/00; F21V 27/005; F21V 23/06; F21Y 2101/02

(57) ABSTRACT

A mountable lighting device that includes one or more light units each having a light housing containing one or more lights, a direct current power connection including a power cord extending from the housing, a two-pin harness connector, and a mounting base connected to the light housing, the mounting base comprising a reversibly mountable face for mounting the light unit onto a surface. A lighting kit containing a lighting device that includes one or more mountable light units, each light unit having a two-pin harness connector. Methods of lighting a workspace include providing one or more mountable light units, attaching a mounting base of each unit to a surface, and connecting the units to a direct current power source.

### TECHNICAL FIELD

Embodiments disclosed herein pertain to lighting devices, lighting kits and method of lighting a workspace.

### BACKGROUND

Providing sufficient lighting for working on or around vehicles and other types of equipment can be a challenge due to small workspaces or areas that are difficult to provide light to because of limited room to place lighting equipment.

Working under the hood of a vehicle, under the vehicle or within tight spaces around and engine or drive train typically utilizes hanging lights, such as treble lights, or stand-mounted lights. Such work can be difficult due to inability of conventional lighting to illuminate precise areas. Further, lighting cords can be problematic in that they can interfere with the work area and/or surrounding areas when strung to connect to an AC power source or any power source that is remote from the vehicle being worked on.

Vehicles that pull trailers can be difficult to hitch in dark areas due to insufficient lighting provided by taillights, the difficulty in utilizing flashlights for such purpose and/or unavailability of appropriately positionable lighting systems.

Another lighting difficulty can occur in utilizing sports/action cameras. Since the subject is in motion, it may not be possible to provide sufficient light for photos or videos utilizing conventional lighting methods.

It would be desirable to provide alternative lighting devices and methods of lighting that address these and other problems.

### BRIEF DESCRIPTION OF THE DRAWINGS

FIG. 1 is a representation of an example lighting device in accordance with one aspect of the invention.

FIG. 2 is a representation of an example lighting device in accordance with another embodiment of the invention.

FIG. 3 is an example lighting device component that can be utilized in certain aspects of the invention.

FIGS. 4 A, B and C show alternative components that can be utilized in particular aspects of the invention.

FIG. 5 is an example component that can be utilized in particular aspects of the invention.

FIG. 6 is an example mounting component that can be utilized in particular aspects of the invention.

FIG. 7 is an alternative example mounting component that can be utilized in particular aspects of the invention.

FIG. 8 is lighting device in accordance with the invention shown in a mounted position.

FIG. 9 is an alternative mount arm in accordance with one aspect of the invention.

FIG. 10 is a cord stabilizer device in accordance with another aspect of the invention.

FIG. 11 is a switch that can be utilized as a component of a lighting device in accordance with the invention.

### DETAILED DESCRIPTION OF EXAMPLE EMBODIMENTS

The invention includes lighting devices that are capable of illuminating small, tight or hard to illuminate areas. Such areas can include workspaces such as engine areas, power train areas, frame areas, underside areas, under dash areas, or other areas of vehicles (e.g. cars, trucks, trains, buses, motorcycles, boats, all-terrain vehicles, planes, etc.). Workspace areas can also include, for example, areas under trailers, areas around vehicle tires or around trailer hitches that can be difficult to illuminate due to non-lighted areas, remote areas in the night, etc. where sunlight or conventional lighting is unavailable or insufficient (such as for hitching a trailer or changing a tire).

Lighting devices of the invention can also be utilized to provide lighting for filming or photographing sports activities or other activities utilizing, for example, a personal wearable or mountable activity camera. For example, lighting devices of the invention can be mounted on a vehicle upon which an action camera is mounted, on a vehicle upon which a wearer of a camera is traveling, or on a vehicle or other object near the activity being filmed or photographed. For instance, lighting devices in accordance with the invention can be mounted on a surface of a boat to provide lighting behind the boat (or another boat) to photograph a water skier.

Devices of the invention are intended for reversible mounting or fixed mounting onto a surface for utilization with a direct current power source. The applications and specific mounting aspects described herein are intended to be examples and are not intended to be limiting. Other non-described surfaces, rails and structures can serve for mounting of the devices of the invention. Similarly, the lighting devices can be utilized in numerous additional applications that are not specifically described but are encompassed by the invention.

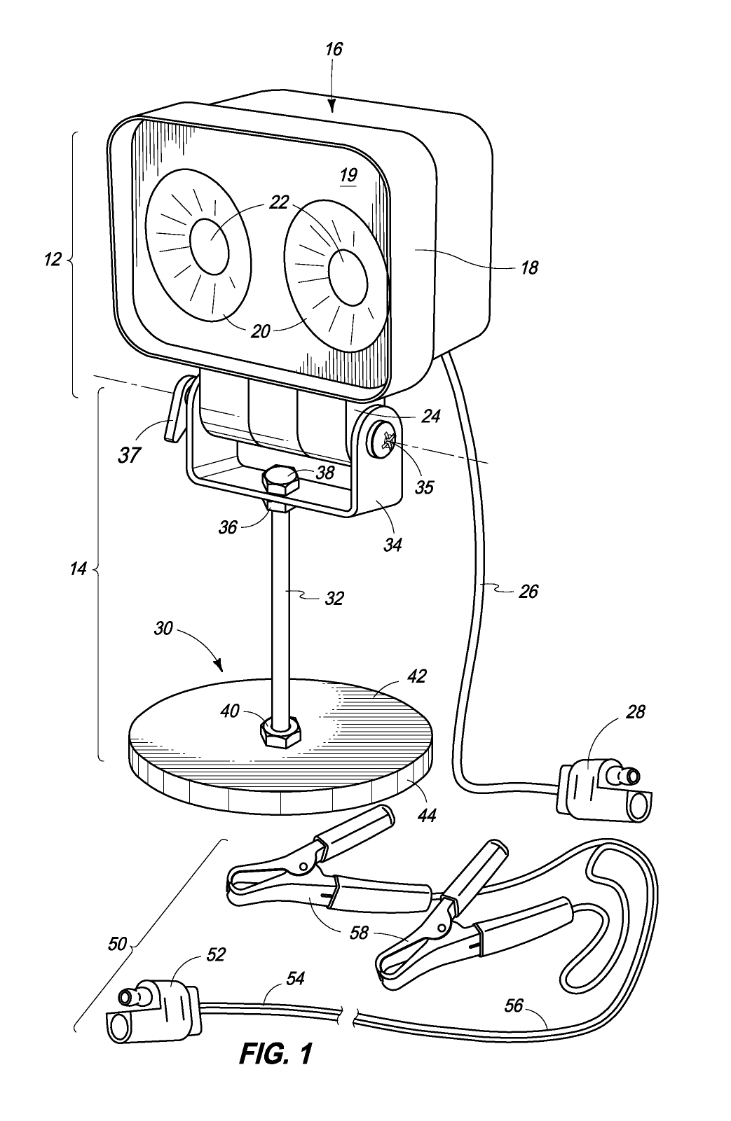

Example lighting devices and components encompassed by the invention are described generally with reference to FIGS. 1-11. Referring initial to FIG. 1, an example lighting device 10 is illustrated. Lighting device 10 can comprise a light unit 12 that includes a light housing 16. Such housing can preferably comprise plastic and can be configured to provide water resistance or waterproofing to internal components. The shape of the housing is not limited to that illustrated in FIG. 1. Housing 16 can have an overall generally cube shape, spherical shape, rectangular box shape, or components of various, shape and/or contours.

Light housing 16 can have a front portion 18 with a front face 19 with one or more light covers 20. The size of the housing is not limited and can house one or more lights 22 configured to provide illumination through light covers 20. The number of lights 22 housed within the housing can be one or can be a plurality. Lights 22 can be spotlights or can be floodlights. Preferred embodiments of the invention can utilize light emitting diode (LED) lights configured for direct current (DC) power.

Front face 19 can have a rectangular shape as shown, or can comprise an alternative shape including but not limited to round, square, polygonal, oval, etc. Further, front face 19 can comprises a single light cover or multiple light covers. Each light cover can cover a single light or can cover multiple lights. Example shapes of light cover(s) 20 can be round as shown, or can have any alternative shape including but not limited to square, rectangular, polygonal, oval, etc.

Light unit 12 can, in some embodiments, comprise an extending connection portion 24 that can be disposed on a bottom of the housing as shown, or can extend along a side, top or back of the housing. Although connector 24 is shown as an extension, connector 24 can alternatively be within or integral with main body housing 16.

A power cord 26 for delivery of direct current to lights 22 can be provided into housing 16. The sight on housing 16 for entry of cord 26 is not limited and can be on a front, back, top, bottom or side of the housing. Power cord 26 can, in particular applications, have a length of up to about 3 feet, although longer cord lengths are contemplated. A power connector 28 can be disposed at a distal end of power cord 26. In some instance, connector 28 can preferably be a two-pin harness connector (shown) although numerous alternative connector types are contemplated. A two-pin harness connection can be preferred for allowing direct connection into a trailer light harness connector (e.g. 4-pin connector). Additionally, a mating two-pin connector can be provided to connect to connector 28 and link the lighting device to a power supply utilizing an appropriate adaptor (discussed below). Thus, the two-pin harness connector can provide versatility to allow multiple types of power connections to be utilized.

Lighting device 10 can further comprise a mounting structure 14. Mounting structure 14 can comprise a mounting base 30, an extension arm 32 and an attachment portion 34 that can, in particular embodiments, be a bracket. Attachment portion 34, extension arm 32 and mounting base 30 can be provided as separate components that can be interconnected (shown), or can be provided as a unitary piece.

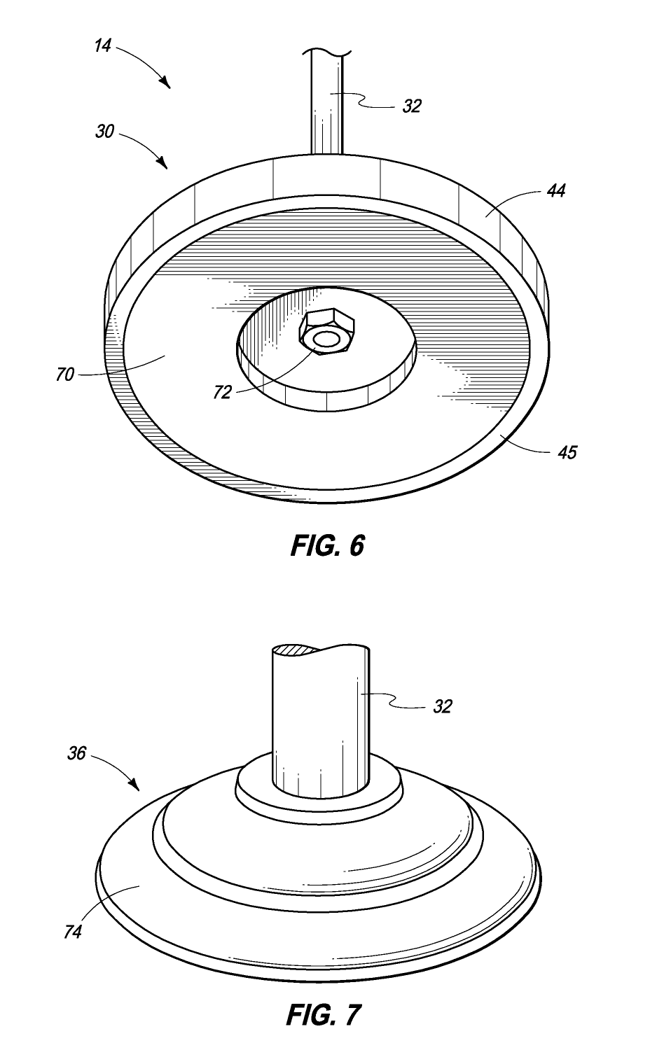

In the illustrated mounting structure, mounting base 30 is attached to extension arm 32 utilizing threading of the arm and a nut 40. As shown in FIG. 6, a second nut 72 can be provided on an underside of mounting base 30 to secure extension arm 32 to the mounting base.

Referring again to FIG. 1, mounting arm 32 can be a bolt having a bolt head 38 and can extend through bracket 34. A tensioning nut 36 can be provided on an underside of the bracket to secure arm 32 to the bracket. Bracket 34 can be attached to housing connection 24 by a screw or pin 35 that passes through the bracket and into or through housing connection 24. In particular embodiments, housing 16 can be rotatable relative to the mounting structure, for example, rotating around screw/pin 35. Where locking of rotation is desirable, screw/pin 35 can be threaded and a thumbscrew tensioning head 37 can be provided to lock housing 16 into a desired position, thereby aiming the emitted light to a desired location.

FIG. 1 depicts but one alternative for connecting mounting base 30 to light housing 16. Bracket 16 can be replaced by a ball or socket to interact with a corresponding ball/socket configuration of housing connector. Accordingly, light unit 12 can be rotatable side-to-side, up and down, or both relative to mounting structure 14.

In some applications, it can be desirable to provide base portion 30 directly attached to lighting unit 12 in an absence of any extension arm 32. Accordingly, base 30 can comprise an attached bracket, ball or socket, etc., or can be directly screwed or pinned into housing 16 or extension 24 of the light unit (not shown).

Although mounting structure 14 is shown as being mounted to a single light unit, a single mounting structure 14 can be configured for mounting multiple light units. The size of mounting base 30 can vary based upon particular applications based upon factors such as size of available surfaces upon which to be mounted. Larger bases can also be provided for heavier or larger light units, or for supporting multiple light units. An example base size (diameter or length) can range, for example from about 1 inch for very small lights, to about 8 inches for heavy or large lights. Where an extension arm 32 is utilized, such arm can have a length of from about 1 inch to about 12 inches.

As additionally illustrated in FIG. 1, lighting device 10 can comprise a power connector 50. Power connector 50 can have a connector 52, which can be a two-pin harness, disposed at a first end of a power cord 54, 56 and a power source connector 58 disposed at a second end of the cord. Power cord 54, 56 can be a single cord or can comprise one or more extension lengths between the first and second ends, as represented by the fragmented cord ends.

In embodiments of the invention where connector 28 of the light unit is other than a two-pin harness connector, connector 52 can be an alternative type of connector configured to engage with connector 28.

In the embodiment shown, power source connector is an alligator clip type battery tender. However, alternative power source connectors are contemplated (see below).

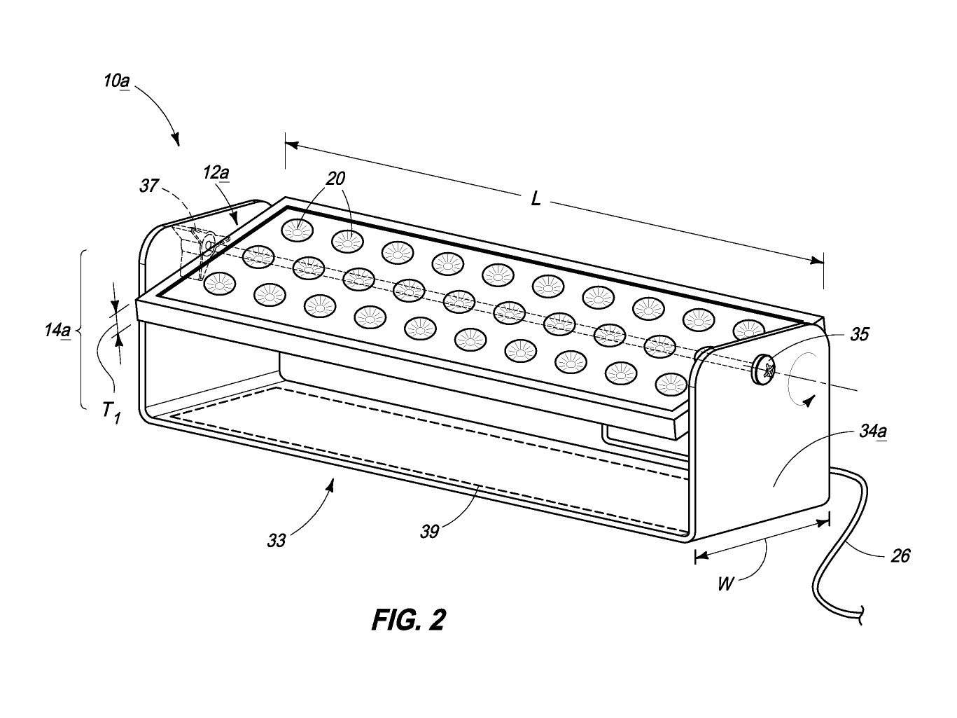

An alternative lighting device 10a configuration is depicted in FIG. 2. Lighting device 10a can optionally have a lighting unit 12a, or multiple units 12a (not shown). Light unit 12a can be a strip, panel or module of LED lights 20 provided in one or more rows across a length L of the unit or in an array (such as, for example, chip-on-board (COB) LED module). The lighting unit 12a can have a thickness T₁ that is relatively thin, for example less than or equal to 1 inch. In some application, T₁ can preferably be less than or equal to 0.5 inch. The length L of the light unit is not limited to a particular size. Example values for L can be from about 3 inches to about 10 feet or more depending upon the available mounting surface. A power cord 26 can be provided to extend from any side or a back surface of light unit 12a. Power cord 26 can be as described above with respect to FIG. 1 and can be configured to connect to DC power by any of the connection configurations herein described.

As shown in FIG. 2, device 10a can utilize a mounting structure 14a that may include an elongated bracket 34a that can be attached to light unit 12a similar to the embodiment depicted in FIG. 1. Accordingly, light unit 12a can be rotated relative to bracket 34a and can be locked at a desired angle utilizing tensioning head 37. Bracket 34 can have a bracket width W that can be less than a width of the light unit as illustrated. Alternatively, W can equal or exceed the width of the light unit.

Device 10a can be mounted to a surface utilizing one or more mounting bases such as those described above with respect to FIG. 1 (or those described below). Alternatively, bracket 34a can be provided to have one or more adhesive strips 39 along a bottom surface 33 of the bracket that will interface a surface to which device 10a will be mounted. Although adhesive mounting is described specifically with respect to the device depicted in FIG. 2, it is to be understood that adhesive mounting may be utilized with any of the lighting devices described herein. Further, a lighting unit (e.g. 12a) can be mounted in an absence of any bracket by providing adhesive directly between the light unit and a surface upon which the device is mounted (not shown).

The embodiment of FIG. 2 can be utilized for lighting any work area utilizing DC power. However, such device may be especially useful for mounting to a vehicle lift and connecting to the DC power (battery) of the vehicle on the lift. Such can avoid the presence of power cords across the floor, extending beneath the lift or otherwise presenting a hazard or interference with performing work on the vehicle. Other lighting devices described herein can also be utilized for mounting on a surface of a lift and connection to the DC power of the vehicle on the lift.

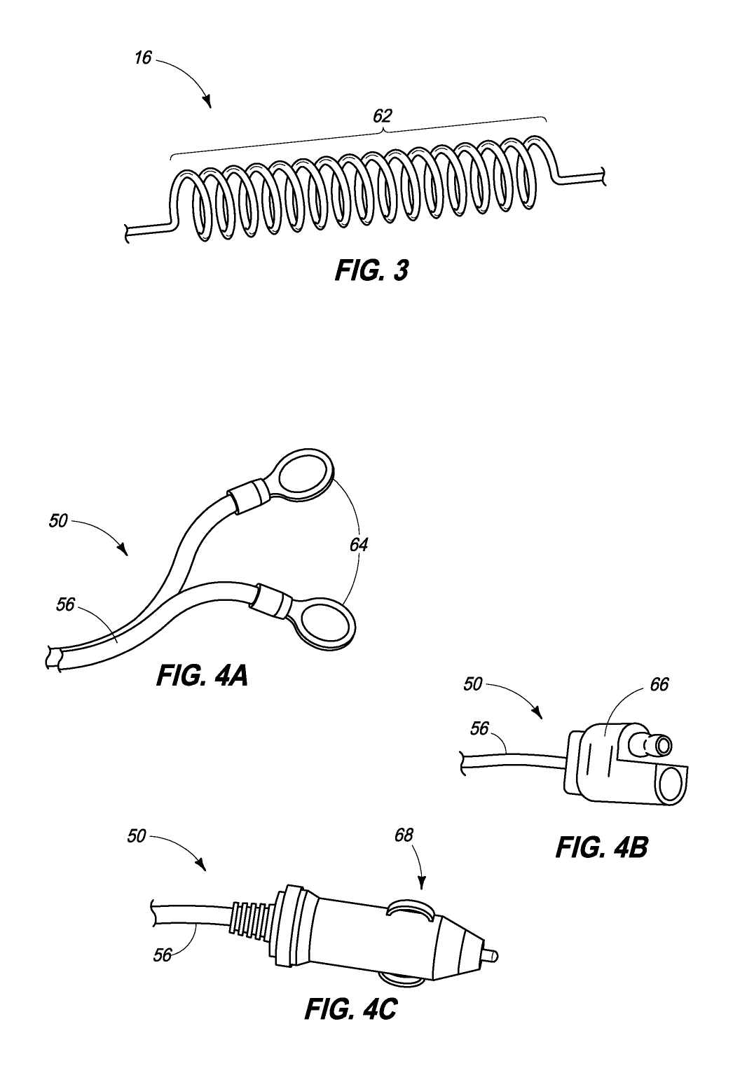

Referring next to FIG. 3, an optional extension power cord 60 can be incorporated into light devices of the invention. Cord 60 can be provided between the two portions 54, 56 of the power cord shown in FIG. 1. Accordingly, appropriate connectors can be provided for incorporation of the extension cord, as will be understood by one of ordinary skill in the art. Although FIG. 3 depicts an expandable coil, cord 60 can be non-coiled and also can be provided to be of an appropriate length for the application, such as to allow connection to a battery from a lighting device positioned proximate a workspace on or near a vehicle. Alternatively, cord 54, 56 shown in FIG. 1 can be a unitary cord of any desired length and can optionally comprise one or more expandable coil portions.

FIG. 4 illustrates example power source connectors that can be utilized in place of the alligator type battery tender connector 58 shown in FIG. 1. FIG. 4A illustrates another example of battery tender connector 64 that can be utilized. Battery tender connectors can be used to directly connect power cord 56 to a battery (such as a battery of a vehicle to be worked on). FIG. 4C shows a plug connector 68 that can be utilized to connect power cord 56 to a battery through an accessory power socket of a vehicle.

FIG. 4b shows a connector 66 that can be utilized on the second end of power cord 56 in some instances. Connector 66 can be, for example, a two-pin harness connector. In particular applications, connector 66 can be plugged into an appropriate receiver of an alternating current (AC) to direct current (DC) convertor that is in turn connected to AC power. Accordingly, an AC power source can be utilized to power the devices or the invention through AC/DC conversion. Alternative adaptor/connectors are contemplated for use in place of the example connector 66 shown in FIG. 4B

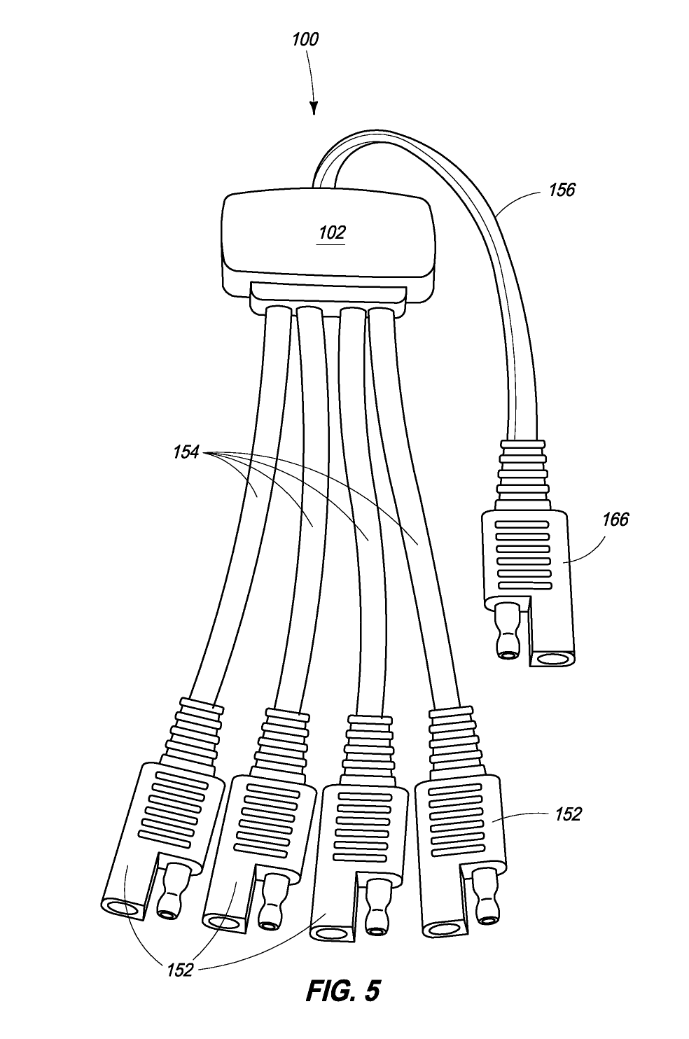

FIG. 5 shows a splitter 100 that can be utilized in embodiments where multiple light devices 10 are desired. Splitter 100 can comprise a splitter body that splits a single cord 156 into a plurality of cords 154 for individual connection to independent lighting devices 10. The individual light devices can be identical or can differ relative to each other. Although splitter 100 is represented as having four cords for connection to four light units, fewer or a greater number of connection cords can be provided. It can be advantageous in some instances to provide multiple light devices for providing efficient lighting of a workspace or area from one or multiple directions. Single cord connection to power can be desired rather than individual connection to minimize the number of cords connected to a power source and minimize the hazard and hassle of having numerous cords around a workspace.

Connector 166 of FIG. 5 can be a two-pin harness connector as illustrated, or can be any alternative type connector. Similarly, connectors 152 that connect to lighting units can preferably be two-pin connectors for connecting to two-pin harness connectors on the light units or can be any alternative style connector. Further, each of connectors 152 and 166 can independently be an alternative connector type or cords 154 can be directly wired to cords 56 of the light devices or directly to the light devices themselves.

Referring to FIG. 6, an alternate view of the mounting base 30 of FIG. 1 is shown. Base 30 can have a housing 44 with a cavity 45 disposed through the underside of the base. Housing 44 can be fabricated from a variety of materials or combinations of materials including but not limited to metal materials, plastic, rubber, etc.

Visible in FIG. 6 is a nut 72 centrally disposed within cavity 45. Nut 55 can be threaded onto arm 32 to connect base 30 to the arm to support the light unit. A magnet 72 can be provided within cavity 45 for magnetic attachment of the light device to a surface of a ferromagnetic metal-comprising material. Accordingly, base 30 can be configured to provide reversible mounting capability.

Magnet 70 is shown as having a circular ring configuration. However, alternative shapes and configurations can be utilized such as solid circular, square, rectangular, etc., or alternatively shaped “ring” magnets can be utilized. In some instances one or more magnetic bars or strips can be utilized.

FIG. 7 shows an alternative mounting base configuration. Base can comprise suction mount 74 such as a suction cup. Suction mount 74 can be circular or any alternative shape. Suction mount 75 can also provide easy mounting and removal of the lighting device on smooth surfaces and can be especially useful where magnetic mounting is not an option.

Alternative reversible or permanent mounting bases are contemplated including but not limited to clamps, clips, bolts, etc. Although the embodiments above are described as having a single mounting base per each light unit, devices of the invention can comprise multiple mounting bases per light unit. Where two or more mounting bases are provided per light unit, the bases can be identical or can differ from one another in configuration, size, shape, and/or attachment mechanism.

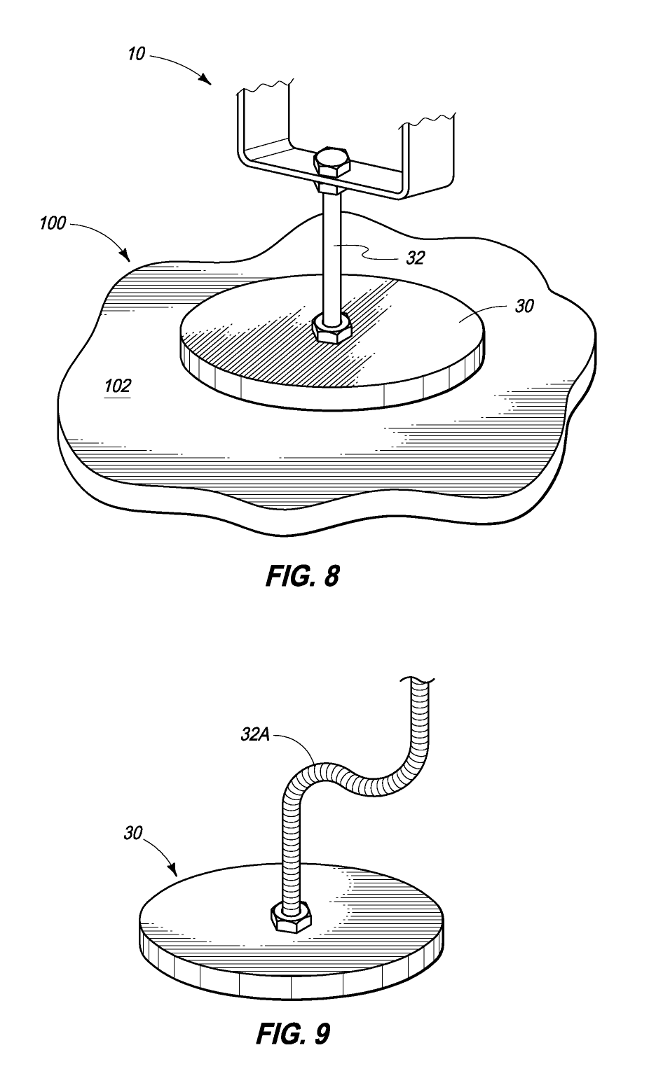

FIG. 8 illustrates attachment of a lighting device 10 of the invention to an object 100 by mounting the mounting base 30 onto a surface 102 of object 102. An appropriate base configuration (described above) can be utilized for a specific surface. For example, where surface 102 comprises ferromagnetic metal, a magnetic base can be utilized. If surface 102 is non ferromagnetic or is a smooth surface, a suction type mounting base can be utilized. In applications where insufficient surface area is available or there is an uneven surface without ferromagnetic components, or where suction and magnets are not suitable, alternative base configurations can be utilized.

FIG. 9 shows an alternative style mounting arm 32A that can be provided between base 30 and a light unit. As shown, arm 32 A can be flexible to allow positioning of the light unit. Such arm style can be advantageous for utilization in circumstances where base 30 cannot be conveniently mounted on a surface that is proximate the work sight. For example, in tight places around an engine, drive train etc., an appropriate surface may be inaccessible for a rigid device. However, a flexible arm may allow positioning of the light in an otherwise non-accessible position.

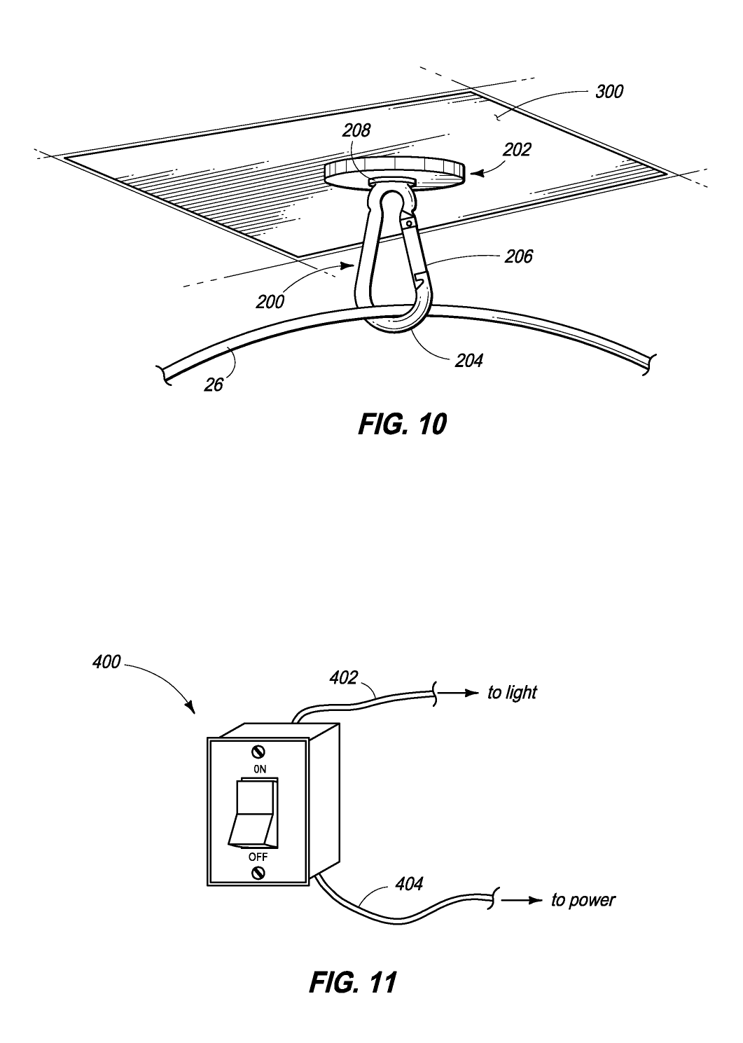

Referring to FIG. 10, an optional cord holder 200 can be provided for retaining a cord in a desired position to inhibit the cord from interfering with performing work and movement within or around a workspace. Cord holder 200 can comprise a hook portion 204 and a base portion 202. Base portion 202 can be of a similar configuration to any of the mounting bases described above and can be utilized for attachment of the cord holder to a surface 300 as described above with respect to the light units. Hook portion 204 can comprise any hook configuration. It can be desirable in some instances that hook portion 204 be a carabineer's type hook. An example carabineer's clip hook is illustrated having a clip 206 that contains a cord 26 within the hook. It can be advantageous to utilize a carabineer's type hook to allow insertion and retention of a power cord.

Hook portion 204 can be directly attached to base 202 or can optionally be attached to a swivel 208 disposed between base 202 and the hook portion. Devices in accordance with the invention can utilize one cord holder or multiple cord holders disposed at various locations between the light unit(s) and a power source.

Another optional feature of the light devices of the invention is shown in FIG. 11. An optional switch 400 can be provided along any of the power cords between the light unit(s) and the power source. Cords 402 and 404 depicted in FIG. 11 can correspond to any of the power cords described above with reference to the lighting devices of the invention. Switch 400 can be a rocker switch as illustrated, or can be any of alternative switch configuration appropriate for DC power, including but not limited to toggle switches, push button switches, etc.

The invention additionally encompasses lighting kits that include one or more of any of the lighting devices described above. The kits may include one or more light units 12 shown in FIG. 1 and/or units 12a of FIG. 2 or variations thereof, that may be identical or can differ relative to each other. The kit can further include one or more mounting structures 14, 14a (and variations described herein) and one or more power connector 50. The kit may optionally include a single type of mounting arm 32, base 30, 32A, connectors 52, 28, and power source connector 58, 64, 68, 66. Alternatively, multiple configurations of any or all of these components can be provided in a single kit for adapting the lighting devices to a variety of spaces, purposes, mounting surfaces, etc.

Additional optional kit components can include, for example, one or more cord holder 200, one or more splitters 100, one or more extension cords 60 and/or one or more switches 400.

Methodology of the invention can include mounting of one or more of the described lighting units to a surface or multiple surfaces proximate an area to be lighted. For lighting a work area associated with a vehicle, the surface(s) upon which the device(s) can be mounted can include but are not limited to surfaces of the vehicle body, frame, engine, etc., and/or surfaces of a lift. Where lighting is desired for hitching a trailer, the lighting units can be mounted to surface(s) of the tow vehicle and/or trailer.

Other surfaces for mounting can include surfaces near an area of an activity to be photographed. For example, one or more light units can be mounted to a surface of a boat to provide a lighted area around the boat to photograph or film an activity such as waterskiing, parasailing, etc. that occur near the boat. Accordingly, lighting systems of the invention can be used in conjunction with specialize cameras such as sports/activity cameras.

Methodology of mounting of the devices of the invention can include providing any of the mounting structures described herein as appropriate for the surface(s) onto which the devices will be mounted. Mounting can include attachment of the mounting structure to the desired surface and can additionally include adjusting an angle and/or aiming of each of the mounted light units to illuminate the area or workspace to be lighted. Mounting can further include adjustment of any mounting arm.

Methodology can further include connecting the lighting units to a DC power supply. In most instances where a vehicle area is to be lighted, the DC power supply can preferably be the battery of the vehicle, although alternative DC sources are contemplated as described above. The connecting can include providing and connecting any of the adaptors, extensions, splitters, etc. described above.

Methodology can optionally include attaching one or more cord holders (e.g. FIG. 10) to one or more surfaces between the position of the mounted light units and the power source. Any of the power cords associated with the device can be provided to pass through the cord holder(s) to retain the cords in a convenient position to prevent or decrease interference of power cords at a work area and/or surrounding area.

Lighting devices, kits and lighting methodology of the invention can advantageously provide lighting into small or hard to access work areas or other areas where conventional lighting is inadequate. Vehicle garages, shops, repair facilities and other work areas such as those around machinery, typically utilize ceiling lights and/or light stands that fail to provide lighting to tight or difficult to light areas on or around a vehicle (e.g. under the vehicle, under the hood, around a wheel, etc.) or on or around machinery. The lighting systems of the invention can provide illumination of these areas.

Additionally, the devices of the invention are configured to utilize DC power which allows for, inter alia, use of the battery of a vehicle to be worked on as the power source. Accordingly, an AC power source is not required. The devices of the invention can therefore be utilized with a variety of DC powered machines, equipment, tools, etc., that are often used where AC lighting is unavailable (e.g. snow blowers, lawn mowers, boats, tractors, personal watercraft, all terrain vehicles, and a multitude of other devices).

Use of the two pin type of connector that can be utilized with lighting devices of the invention can provide additional advantages including but not limited to direct connectability to the lighting harness of a vehicle tow package and/or integration into any wiring harness for more permanent need or repeated use.

Because the lighting devices of the invention utilize DC power, the systems of the invention can be utilized in conjunction with almost any solar power system.

In compliance with the statute, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

What is claimed is:

1. A mountable lighting device comprising:
one or more light units, each of the light units comprising:
a light housing containing one or more lights;
a direct current power connection including a power cord having a first end extending from the housing and a two-pin harness connector disposed at a second end; and
a mounting base connected to the light housing, the mounting base comprising a reversibly mountable face for mounting the light unit onto a surface.

2. The lighting device of claim 1 wherein the one or more lights are light-emitting diode (LED) lights.

3. The lighting device of claim 2 wherein at least one of the one or more lights is a chip-on-board (COB) LED light.

4. The lighting device of claim 1 wherein at least one of the one or more lights is a floodlight.

5. The lighting device of claim 1 wherein at least one of the one or more lights is a spotlight.

6. The lighting device of claim 1 wherein the two-pin harness connector is a first two-pin harness connector and further comprising a power connector having a second two-pin harness connector configured to connect with the first two-pin harness connector and having a power source connector selected from a battery tender and an accessory-socket power plug.

7. The lighting device of claim 6 the power source connector comprises an accessory-socket power plug, and wherein the power connector further comprises an AC to DC adaptor.

8. The lighting device of claim 1 comprising at least two light units, each of the at least two light units being independently mountable.

9. The lighting device of claim 1 wherein the light housing is rotatable relative to the mounting base.

10. The lighting device of claim 1 wherein the mounting base comprises a magnetic mounting surface.

11. The lighting device of claim 1 wherein the mounting base comprises a suction cup.

12. The lighting device of claim 1 further comprising a cord retainer hook configured to be mounted on a surface and configured to retain one or more electrical cords associated with the lighting device.

13. A mountable lighting device kit comprising:
one or more light units, each of the light units comprising:
a light housing containing one or more lights;
a direct current power connection including a power cord having a first end extending from the housing and a two-pin harness connector disposed at a second end; and
a mounting structure comprising a reversibly mountable face and a connection to the light housing; and
one or more additional components selected from the group consisting of a cord retainer hook, a power switch, an alternative style mounting base, an electrical splitter for connecting multiple light units to a single power supply, a power connector comprising a two-pin harness connector disposed at a first end and a power source connector disposed at a second end, and an extension cord.

14. The kit of claim 13 further comprising an AC to DC power converter.

15. The lit of claim 13 wherein the one or more lights are light-emitting diode (LED) lights.

16. The kit of claim 13 further comprising one or more mount extension arms configured to be positioned between and connected to each of the light housing and the mounting base.

17. A method of lighting a workspace, comprising:
providing one or more light units, each of the light units comprising:
a light housing containing one or more lights;
a direct current power connection including a power cord having a first end extending from the housing and a power connector disposed at a second end; and
a mounting structure comprising a mountable face and a connection to the light housing;
independently attaching the mounting base of each of the one or more light units to one or more surfaces near the workspace; and
connecting each power connector to a DC power source.

18. The method of claim 17 wherein the workspace is associated with a vehicle and the surfaces comprise a surface of the vehicle.

19. The method of claim 17 wherein the workspace is associated with a vehicle and the surfaces comprise a surface of a lift.

20. The method of claim 17 wherein the power connector is a two-pin harness connector.

21. The method of claim 17 wherein the workspace is associated with a trailer hitch on a vehicle and the surface comprise at least one of a surface of the vehicle and a surface of a trailer.

22. The method of claim 17 wherein the workspace is associated with a vehicle and the one or more light units are connected to a battery of the vehicle utilizing.
